(19) United States
(12) Patent Application Publication
(10) Pub. No.: US 2006/0062989 A1
(43) Pub. Date: Mar. 23, 2006

(54) Biodegradable material for recording thereon

(76) Inventor: Hiroshi Enomoto, Saitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/221,912

(22) Filed: Sep. 9, 2005

(30) Foreign Application Priority Data
Sep. 17, 2004 (JP) 2004-271769

(51) Int. Cl. B32B 3/26

(52) U.S. Cl. 428/304.4

(57) ABSTRACT

There is disclosed a material for recording thereon which comprises a biodegradable resin and at least one surface of which is a porous recording surface, wherein said porous recording surface contains (A) a biodegradable resin and (B) a natural inorganic filler and/or an organic filler in a mass ratio (B)/(A) being in the range of 0.1 to 5.0, and possesses a smoothness of at least 500 sec and besides an average pore diameter in the range of 0.01 to 10 μm. The above material is excellent in biodegradability, ink absorptivity, printing adaptability by using any of various inks, printing adaptability by a thermal transfer recording system, inkjet recording system and the like, writing properties, stamping properties, etc., and is capable of contributing to the steadily increasing waste disposal problem.

### BACKGROUND OF THE INVENTION

1. Field of the Invention

The present invention relates to a biodegradable material for recording thereon. More particularly, it pertains to a biodegradable material for recording thereon which is excellent in printing adaptability for various inks, printing adaptability by thermal transfer recording system, inkjet recording system and the like, writing properties and stamping properties; which has a recording layer improved in ink absorptivity on at least one side thereof, and which has biodegradability that facilitates disposal of, incineration and the like.

2. Description of the Related Arts

In recent years, plastics films have widely been employed in such applications as requiring smooth images utilizing the strength, water resistance and surface smoothness, or requiring transparency in OHP. Accordingly the disposal amount of these materials for recording thereon increases year by year. Thus plastic products occupy the major portion of disposed material for recording, but are not decomposed semi-permanently, thereby raising a serious problem as a material which is extremely difficult to treat.

Although it is possible to subject the material for recording thereon to an incineration treatment, the plastic products have high heat of combustion, thus imposing much thermal loads on a combustion furnace, and on the other hand, there is the possibility that the plastic products become responsible for the occurrence of dioxin depending on the type thereof

Owing to the raised consciousness for the environmental issues accompanying the above-mentioned problems, development is vigorously carried out on commodities which take advantage of materials having biodegradability. The biodegradable materials markedly decrease the load imposed upon the environment, since it is finally decomposed into water and carbon dioxide by microorganisms and enzymes. Of these biodegradable materials, polylactic acid resin originating from a vegetable such as corn, maize, starch or the like has received increasing attention as characterized by having nearly the same properties as those of polyethylene resin, and is extensively investigated as prospective resin usable in a substrate and recording layer in the field of materials for recording thereon.

As examples of the biodegradable materials that are employed in the field of materials for recording thereon, there are proposed degradable coating which has favorable physical properties of coated film and which is formed from biodegradable polyester that contains 70 to 100 molar % of lactic acid reside group, has a molar ratio of L-lactic acid to D-lactic acid (L/D) being 5.0 to 19.0, possesses crystallinity and heat of fusion observed, for instance, as disclosed in Patent Literature No. 1; an inkjet recording medium composed of a support made of a polylactic acid film, an image receiving layer soluble in an organic solvent and comprising lactic acid, an anchor coat layer and an ink receiving layer that are formed in this order, for instance, as disclosed in Patent Literature No. 2; a printing film which is obtained by using as a substrate layer, a crystalline lactic acid base polyester composition containing polylactic acid and lactic acid base polyester and having a melting point of 120° C. or higher, using as an ink receiving layer, an amorphous composition containing polylactic acid and lactic acid base polyester and having a softening point of 40 to 110° C., and coextruding the compositions, for instance, as disclosed in Patent Literature No. 3; a biodegradable resin composition (to be applied to polylactic acid films) which is improved in such physical properties as flexibility, toughness and solvent resistance, and which is obtained by dissolving an aliphatic polyester resin and an isocyanate compound in a solvent, mixing the same, drying the solvent to remove it and heat curing the composition, for instance, as disclosed in Patent Literature No. 4.

The substrate being used in the Patent Literature No. 1 is a biaxially oriented polylactic acid film, while the substrate being used in the Patent Literature No. 3 is a crystalline lactic acid base polyester composition containing polylactic acid and lactic acid base polyester and having a melting point of 120° C. or higher, and in which a crystalline lactic acid film is used as the substrate. In regard to the Patent Literatures Nos. 2 and 4, polylactic acid is used as the substrate, but no definite description is made on crystallinity. However as described in the Patent Literature No. 2 that polylactic acid usually bears continuous units of L-lactic acid as structural unit, is high in crystallinity, and is insoluble in general purpose organic solvents ([0008]), crystalline polylactic acid is usually used in the substrate taking into consideration the requisite characteristics thereof.

On the other hand, amorphous polylactic acid resin soluble in general purpose organic solvents is used in a binder for a recording layer and ink receiving layer. Such being the case, polylactic acid base resin is used for each of the substrate and recording layer. However since the crystalline polylactic acid to be used in the substrate is usually insoluble in general purpose organic solvents, it cannot be said that sufficient adhesiveness is always assured between the substrate and recording layer or ink receiving layer. In order to dissolve crystalline polylactic acid, a halogen base organic solvent can be used, but is not favorable because of possibility of causing an environmental problem.

Nevertheless with regard to the material for recording thereon which is formed in any procedure, it is necessary to properly select an ink upon printing. The above-mentioned polylactic acid base resin has low ink absorptivity particularly for general process ink, soybean oil ink, non-VOC ink and the like, thus rendering itself unsuitable for printing paper.

On the other hand, there is proposed that a biodegradation rate is controllable by controlling void ratio in a biodegradable porous membrane obtained by dissolving copolymer having a molar ratio of L-lactic acid to D-lactic acid (L/D) being 90:10 to 10:90 in an organic solvent, applying the resultant solution onto a substrate, thereafter immersing the same in a solvent which has affinity for the above-mentioned organic solvent and doesn't dissolve a polylactic acid base copolymer, and subsequently drying the same (refer to Patent Literatures No. 5 ) ([0013]). Nevertheless, how to enable the biodegradability to be enhanced by how to control the void ratio still remains unsolved.

Under such circumstances, in order to provide a material for recording thereon which is excellent in printing adaptability for various inks including general process ink, soybean oil ink, non-VOC ink and the like, in printing adaptability by thermal transfer recording system, inkjet recording system and the like, in writing properties and in stamping adaptability, it is eagerly desired to contrive the improvement in ink absorptivity.

Patent Literatures No. 1: Japanese Patent Application Laid-Open No. 204378/1998 (Heisei 10)

Patent Literatures No. 2: Japanese Patent Application Laid-Open No. 321072/1999 (Heisei 11)

Patent Literatures No. 3: Japanese Patent Application Laid-Open No. 94586/2003 (Heisei 15)

Patent Literatures No. 4: Japanese Patent Application Laid-Open No. 251368/1998 (Heisei 10)

Patent Literatures No. 5 Japanese Patent Application Laid-Open No. 20530/2002 (Heisei 14)

### SUMMARY OF THE INVENTION

It is an object of the present invention relating to a biodegradable material for recording thereon to provide under such circumstances, a material for recording thereon which has favorable ink absorptivity, which is excellent in printing adaptability for various inks, printing adaptability by thermal transfer recording system, inkjet recording system and the like, writing properties and stamping properties, and which has excellent biodegradability capable of contributing to solving the steadily increasing waste disposal problems.

Other object of the present invention will become obvious from the text of the specification hereinafter disclosed.

In order to achieve the above-mentioned objects, intensive extensive research and investigation were accumulated by the present inventors. As a result, it has been discovered that the objects can be achieved by using a biodegradable material for recording thereon which contains a biodegradable resin and which comprises a porous surface having a smoothness and besides an average pore diameter each within a specific range on a recording surface of the material.

The present invention has been accomplished by the foregoing findings and information. That is to say, the present invention provides a material for recording thereon as described hereunder.

1. A material for recording thereon which comprises a biodegradable resin and at least one surface of which is a porous recording surface, wherein said porous recording surface contains (A) a biodegradable resin and (B) a natural inorganic filler and/or an organic filler in a mass ratio (B)/(A) being in the range of 0.1 to 5.0, and possesses a smoothness of at least 500 sec and besides an average pore diameter in the range of 0.01 to 10 μm;

2. The material for recording thereon as set forth in the preceding item 1, which is of a monolayer structure containing (A) a biodegradable resin and (B) a natural inorganic filler and/or an organic filler; and

3. The material for recording thereon as set forth in the preceding item 1, which is of a multilayer structure wherein a layer having a porous recording surface containing (A) a biodegradable resin and (B) a natural inorganic filler and/or an organic filler is formed on at least one surface of a substrate composed principally of a biodegradable resin.

### DESCRIPTION OF THE PREFERRED EMBODIMENTS

In the following, the present invention will be described in more detail.

The material for recording thereon to be used in the present invention comprises a biodegradable resin. Examples of the (A) biodegradable resin include polyalkylene succinate such as lactic acid base polymer, polybutylene succinate, polybutylene succinate/azibate, polybutylene succinate/terephthalate, polyethylene succinate and polybutylene succinate/carbonate, polyglycol acid, polycaprolactone, polyhydroxybutyric acid, polyhydroxyvareric acid, copolymer of hydroxybutyric acid/hydroxyvareric acid and the like. The above-cited biodegradable resin may be used alone or as a mixture of at least two species.

As the above-exemplified lactic acid base polymer, there are cited polylactic acid, copolymer of lactic acid and an other hydroxycarboxylic acid and the like. Of these, the polylactic acid, which is obtained from vegetable starch such as corn and maize by subjecting the same to lactic acid fermentation, is excellent in biodegradability because of its being easily decomposed into lactic acid by means of hydrolysis. Moreover the polylactic acid is characterized in that it can be optionally chemically synthesized into a wide range of products from rubbery soft flexible raw material to hard rigid material by controlling the molecular weight and copolymerization with other monomer. Further in recent years, it is markedly expanding the market by means of expansion schedule and cost reduction, thus rendering itself excellent in productivity and processing adaptability. In view of the various standpoints, polylactic acid is preferable as the biodegradable resin.

In order to impart enhanced adhesivity and additional performances to the porous recording layer, it is possible to mix a resin other than a biodegradable resin. Examples of resins other than a biodegradable resin include acrylic resin, vinyl chloride resin, vinyl chloride/vinyl acetate copolymer, polyester resin, ethylene/vinyl acetate copolymer, urethane resin and polyvinyl butyral resin. However it is preferable that the biodegradable resin occupies at least 50% by mass of the total sum of the same and the resin other than a biodegradable resin.

The above-mentioned polylactic acid resin is preferably crystalline polylactic acid resin having a weight average molecular weight in the range of 10,000 to 1,000,000, preferably 100,000 to 300,000. Any of polylactic acid base resin is acceptable provided that it bears a lactic acid structure in its constitutional units, and is exemplified, for instance, by a resin obtainable by subjecting L, D lactide which is a cyclic dimer of lactic acid to ring-opening polymerization and a resin obtainable by the polycondensation of L-lactic acid or D-lactic acid. These resins made into each a sheet are used, and preferably are subjected to orientation treatment for enhancing thermal stability. Since these polylactic acid resins are made from the lactic acid as the raw material present in a large number of organism bodies, they have biodegradability by microorganism. Thereby the resins, when disposed of in the environment, are decomposed and made into resources with the lapse of time by microorganisms in the natural world, and finally converted into water and carbon dioxide. For these reasons, there is no anxiety about environmental pollution caused by waste materials.

In addition, the biodegradable material for recording thereon according to the present invention comprises a biodegradable resin, and has a porous recording surface comprising (A) a biodegradable resin and (B) a natural inorganic filler and/or an organic filler on at least one surface of the material. The material may be of a monolayer structure comprising (A) a biodegradable resin and (B) a natural inorganic filler and/or an organic filler. Alternatively it may be of a multilayer structure wherein a layer having a porous recording layer comprising (A) a biodegradable resin and (B) a natural inorganic filler and/or an organic filler is formed on at least one surface of a substrate composed principally of a biodegradable resin. In the case of the multilayer structure, the substrate which is composed principally of a biodegradable resin as a resin component signifies that it comprises a biodegradable resin or a biodegradable resin along with a resin other than a biodegradable resin, and that the proportion of the biodegradable resin is at least 50% by mass.

As the biodegradable resin and the resin other than a biodegradable resin, there are usable those that have been cited as usable in the porous recording layer.

That is to say, the biodegradable material for recording thereon according to the present invention may be of a monolayer structure which in itself is a porous recording surface or of a multilayer structure in which a layer having a porous recording surface is formed on either or both the surfaces of the substrate. Moreover the material may be of a multilayer structure in which a layer having a porous recording surface is formed on both the surfaces of the substrate for the purpose of preventing a curl, or may be equipped with two or more layers each having a porous recording surface on one surface of the substrate for the purpose of preventing a crack. As a method for forming the multilayer structure, there are usable publicly well known methods such as a coating method wherein a coating liquid into which necessary components are dispersed or dissolved in a solvent is applied as a coating, followed by drying so that layers are formed; a method which comprises pasting layers themselves via an adhesive; so called coextrusion method wherein a plurality of raw materials are extruded from a plurality of extruders, and then joined together to form the layers; and so called extrusion laminating method wherein a film is directly extruded on a film from an extruder, while pasting and laminating the films.

In the case of a multilayer structure, there is no possibility of peeling off of a print or a recording layer upon printing provided that the adhesiveness among the layers is favorable, thereby making it usable as is the case with the monolayer structure.

Further the material for recording thereon according to the present invention may be equipped with a layer other than a layer having a porous recording surface, for instance, with a layer having a suitable opaqueness for the purpose of enhancing the concealing properties with a ultraviolet absorbing layer or with a curl prevention layer. Preferably, a biodegradable resin is used also in a layer other than a layer having a porous recording layer. The overall thickness of the material for recording thereon according to the present invention, which is not specifically limited in any case of the monolayer structure and multilayer structure, is in the range of usually 1 to 1,000 μm approximately, preferably 10 to 500 μm.

The thickness of the layer having a porous recording layer in the instance of the multilayer structure (after being dried in the case of coating) is in the range of preferably 0.1 to 100 μm, more preferably 1 to 50 μm. The thickness made to be at least 0.1 μm eliminates the occurrence of bleeding due to insufficiency in ink absorbing capacity, and the thickness made to be at most 100 μm eliminates lowering of the strength of the layer having a porous recording layer.

As the coating method in the case of forming the multilayer structure, it is possible to use any of various previously well-known coating method such as reverse roll coat method, air knife coat method, gravure coat method and blade coat method. For the purpose of enhancing adhesiveness and/or wettability to the layer having a porous recording layer, it is possible as desired, to subject the substrate to a surface treatment on one or both the sides by means of oxidation method, unevenly patterning method or the like.

As the above-mentioned oxidation method, there are cited, for instance, corona discharge treatment, hot air treatment and the like. As the unevenly patterning method, there are cited, for instance, sand blast method, solvent treatment method and the like. The foregoing surface treatment method, which is properly optionally selected according to the type of the substrate, is in general, preferably corona discharge treatment method from the viewpoint of working effect and operability. Moreover, the substrate surface can be subjected to an adhesion facilitating treatment.

In regard to the material for recording thereon according to the present invention, the porous recording layer has smoothness of at least 500 sec, preferably at least 800 sec on at least one surface thereof. The smoothness made to be at least 500 sec results in enhanced glossiness and excellent beauty. The smoothness is measured by JIS as described hereunder.

On the other hand, the porous recording layer has an average pore diameter in the range of 0.01 to 10 μm, preferably 0.1 to 5 μm. The average pore diameter made to be at least 0.01 μm assures high absorptivity of an ink and drying in a short period of time, thus preventing images from flowing away. Moreover the average pore diameter made to be at most 10 μm enables glossiness to be enhanced and an increase in bleeding to be prevented, since the rate of transverse ink spreading is higher than the rate of ink absorption, thus eliminating a fear that the surface layer becomes brittle owing to insufficient strength.

With regard to the biodegradability, the average pore diameter made to be at least 0.01 μm makes it unnecessary to place the material to be biodegraded in a definite environment such as in composts in order to accelerate decomposition, hence facilitating the decomposition in a general soil. The biodegradable resin is decomposed from the surface thereof by lytic enzymes that are produced from microorganisms, and the decomposition rate increases with an increase in the average pore diameter. Taking into consideration the size of microorganisms, an average pore diameter in the range of 0.1 to 5 μm facilitates fixation thereof, and besides increases the decomposition rate.

As the method for forming the above-mentioned porous recording surface, a wet solidification method is effectively usable because of easily obtainable smoothness and average pore diameter each in specific range. The wet solidification method is a method in which, for instance, a biodegradable resin dissolved in a solvent or the resultant solution incorporated with a filler is formed into a monolayer structure or a multilayer structure by coating the substrate, and thereafter any of the structure is passed through a liquid which is compatible with the above-mentioned solvent but is incompatible with the resin, so that the resin is solidified and dried to form a porous coating surface.

Specific examples of the solvents to be used for the wet solidification method include dimethylformamide, dimethylsulfoxide, dimethylacetoamide, tetrahydrofuran, γ-butyrolactone, etc. and a mixture thereof. Of these, dimethylformamide (DMF) is most preferably usable. Water is most preferably usable as the liquid which is compatible with DMF but is incompatible with the biodegradable resin. The method described above is effective in the case of controlling the average pore diameter on the surface, since it is possible to enlarge the average pore diameter on the surface by passing the structure through water at ordinary temperature to solidify the same and subsequently passing it through hot water at 50 to 100° C. for drying.

In the case of coating the substrate regarding the multilayer structure, it is desirable that the biodegradable resin to be applied to at least either surface of the substrate composed principally of a biodegradable resin is an amorphous polylactic acid, of which is preferable an amorphous polylactic acid having weight average molecular weight of at least 10,000 and softening point in the range of 40 to 110° C. approximately. A copolymer of D-lactic acid and L-lactic acid is usable as the amorphous polylactic acid. The copolymerization ratio of D-lactic acid to L-lactic acid is not specifically limited, provided that the resultant polylactic acid is imparted with desirable molecular weight, favorable softening point and amorphousness.

L-lactic acid is obtained inexpensively, but D-lactic acid is expensive. On the other hand, since the lactic acid obtained by chemical synthesis is a racemic mixture of D-lactic acid and L-lactic acid, amorphous polylactic acid bearing D, L-lactic acid structure can inexpensively be synthesized by the production process comprising adding the racemic mixture to the raw material for synthesizing the amorphous polylactic acid resin. Further the polylactic acid resin which satisfies the above-mentioned requirements is obtainable by the ring-opening polymerization via D, L-lactide that is cyclic dimer of lactic acid as mentioned above.

The material for recording thereon according to the present invention, which is imparted with biodegradability, is well suited in the case of being disposed of in a natural environment, while being finally decomposed into water and carbon dioxide through the metabolizatiom of microorganisms in the natural environment.

For the purpose of enhancing the absorptivity and strength of an ink on the recording surface in the present invention, (B) a natural inorganic filler and/or an organic filler is added to the material. The mixing ratio of (B) a natural inorganic filler and/or an organic filler to (A) a biodegradable resin {the ratio of (B)/(A) by mass} is in the range of preferably 0.1 to 5.0, more preferably 0.3 to 4.0. By setting the ratio of the filler to the biodegradable resin in the foregoing range, the absorptivity and strength of an ink on the recording surface are enhanced. By setting the ratio (B)/(A) on at least 0.1, a proper ink quantity absorbing performance and a moderate drying rate are assured without causing bleeding. Further by setting the ratio (B)/(A) on at most 5.0, moderate resin adhesion performance is obtained without bringing about brittle recording surface.

Examples of the natural inorganic filler include, for instance, calcium carbonate, talc, clay, kaolin, titanium oxide and silica. The natural inorganic filler has an average particle diameter of preferably at most 30 μm, more preferably in the range of 0.1 to 20 μm. The natural inorganic filler brings about moderate roughness on a surface layer for writing with a pencil and at the same time, exhibits the effect on absorbing water base and oil base inks. The natural inorganic filler, although is not metabolized by the microorganisms in a natural environment, is obtained by subjecting the mineral resources inherently existing under the ground to a refining treatment to some extent, and accordingly is problem-free even when being disposed of in an environment so that some of the resin remains after the decomposition.

As natural organic fillers, starch base particulates and cellulose based particles are excellent from the viewpoint of biodegradability. The starch base particulates are exemplified by, for instance, particulates of rice starch, corn starch, potato starch and the like. The cellulose based particles are exemplified by, for instance, particulates of tosco hemp cellulose powder, cellulose acetate powder and the like. The natural organic fillers have each an average particle diameter preferably being at most 50 μm, more preferably in the range of 1 to 30 μm. Preferably, the fillers for the substrate are selected for use from the same fillers exemplified as the fillers to be used for the porous recording layer.

Furthermore, the biodegradable resin may be incorporated as desired with any of a variety of additives. For instance, adding polycarbodiimide enables the hydrolytic properties to be moderately regulated.

In addition, the material for recording thereon of monolayer structure or the layer placed on the substrate may be incorporated at need with a variety of additives such as defoaming agents, antistatic agents, ultraviolet absorbers, fluorescent whitening agents, antiseptics, pigment dispersants, increasing viscosity agents and the like to the extent that the objects of the present invention are not impaired thereby. Preferably, the content of the additives is suppressed to at most 30% of the total amount of the material for recording thereon according to the present invention.

The working effects and advantages of the present invention will be summarized as follows. The material for recording thereon according to the present invention brings about prominent effects and advantages in that it is improved in ink absorptivity, is thereby excellent in printing adaptability for various inks including general process ink, soybean oil ink, non-VOC ink (only vegetable oil is used as the solvent), etc., in printing adaptability by thermal transfer recording system, inkjet recording system, etc., in writing properties and in stamping properties, etc., and besides facilitates disposal and incineration owing to its biodegradability. Accordingly the material for recording thereon is used in identity papers, driver's licenses, commutation tickets, cash cards, ID cards, commodity display labels(bar codes), advertisement propaganda labels (stickers), general purpose labels, decorative illumination paper, molded processed articles, posters, calendars, commercial prints for general purpose such as magazines, packaging sheets, prints for packaging such as cosmetic boxes, etc. and at the same time, is employed for sealing with water base and oil base stamps, writing with water based and oil based ball-point pens, pencils and the like, and printing with any of various printers of thermal transfer recording system, inkjet recording system, etc. In particular, it is well suited for use in the case of being discarded or disposed of after a definite period of application.

In the following, the present invention will be described in more detail with reference to comparative examples and working examples, which however shall never limit the present invention thereto.

The smoothness and average pore diameter were each measured in accordance with the method as described hereunder.

(1) Smoothness

Smoothness was measured on the basis of JIS P-8119 {Method for testing smoothness of paper and paper board with Beck smoothness testing machine} by the use of a Beck smoothness testing machine (manufactured by Toyo Seiki Seisaku-Sho, Ltd.).

(2) Average Pore Diameter

The surface of specimens were observed with a scanning electron microscope (trade name: S-3000H, manufactured by ©Hitachi-Ltd.), and the average pore diameter was measured with a general-purpose image processing soft NS2KPro (manufactured by NANO System Corporation.).

The material for recording thereon was evaluated in accordance with the method as described hereunder.

(1) Ink Setting Property

By the use of a RI print aptitude tester (manufactured by Ishikawajima Industrial Machinery-Co., Ltd.), a material printed with an offset printing ink was pressed on base paper under constant pressure so that the transfer state of the ink onto the base paper was observed, and the ink setting property was visually evaluated on the basis of the following criterion. There were used a general process ink (trade name: Super TEKPLUS indigo, manufactured by T & K TOKA Co., Ltd.), soybean oil ink (trade name: Naturalith-100 indigo, manufactured by DAINIPPON INK AND CHEMICALS, INCORPORATED.), and non-soybean oil ink (trade name : Kartonking winEcoo-NV indigo, manufactured by TOYO INK MFG. Co., Ltd.)

◯: ink was immediately absorbed

Δ: despite rather poor ink-absorptivity, there is no practical problem

X: markedly poor ink-absorptivity

(2) Printing Adaptability by Inkjet Recording System

Color record images were formed using pigment base solid inks of four colors including yellow, magenta, cyan and black by the use of an inkjet printer (trade name: Tektronix PHASER 850, manufactured by Fuji Xerox Co., Ltd.). Immediately after the printing, recorded portion of recorded product was visually observed, while the color reproducibility condition was evaluated on the basis of the following criterion.

◯: clear image was formed

Δ: rather poor ink-absorptivity, with inferior printing quality

X: ink runoff observed with image bleeding

(3) Printing Adaptability by Thermal Transfer Recording System

Color record images were formed using molten resin type inks of four colors including yellow, magenta, cyan and black by the use of a thermal transfer printer (trade name: Smile Profile N-800 II, manufactured by Alps Co., Ltd.). Immediately after the printing, recorded portion of recorded product was visually observed, while the color reproducibility condition was evaluated on the basis of the following criterion.

◯: clear print was formed

Δ: poor dot reproducibility with inferior printing quality

X: failure to transfer a dot with printing being almost impossible

(4) Writing Properties

Writing was conducted with pencils (trade name: Tombow 8900-2H/-H-/F-/-HB/-B/-2B, manufactured by Tombow Pencil Co., Ltd.), ball-point pens (trade name: Ballpoint pen N-5100, manufactured by Zebra Co., Ltd.), water-based pens (magic lashon water-based pen, manufactured by Teranishi Chemical Industres Co., Ltd.) and oil-based pens (trade name: Tombow oil-based pen, manufactured by Tombow Pencil Co., Ltd.). Thus evaluation was made on the basis of the following criterion.

◯: clear without bleeding or low spot

Δ: readable despite occurrence of bleeding or low spot

X: non-readable by bleeding and low spot

(5) Stamping Properties

Sealing was conducted with a stamping ink for sealing [Sealing stamp ink (vermilion inkpad-Ecos MG50EC), manufactured by Shachihata Inc.], and immediately thereafter the sealed portion was rubbed against a finger tip. Thus evaluation was made on the basis of the following criterion.

◯: clear without bleeding

Δ: readable despite occurrence of bleeding

X: non-readable by bleeding

(6) Adhesiveness

Adhesiveness was evaluated in accordance with gridiron tape method (JIS K-5400-1990). Specifically gridiron cuts that penetrated the layer having a porous recording surface and reached substrate surface were formed, and cellophane adhesive tape (No. 405, width 18 mm, manufactured by Nichiban Co., Ltd.) were pasted on the gridiron surface. The pieces were strongly rubbed against a thumb five times, and then were suddenly pulled off in a direction of 45 degrees, while the lacking portion area which was of the recording portion with entirely square area and which was attached to the cellophane tape side was obtained. Thus evaluation was made on the basis of the following criterion.

◯: no lacking portion was observed

Δ: lacking portion of at most 50%

X: lacking portion of more than 50%

(7) Biodegradability

Specimens were buried in an upland soil, and after the lapse of 3 months the biodegraded area was evaluated on the basis of the following criterion.

◯: biodegraded area of at least 30%

Δ: biodegraded area of less than 30%

X: not biodegraded at all

(8) Glossiness

Printing was conducted in the same manner as in the above-mentioned (1) ink setting property except that a process ink was used. By the use of a Digital Variable Gloss Meter (manufactured by SUGA TEST INDUSTRIES Co., Ltd.), the glossiness of the printed and non-printed portions were measured on the basis of JIS P-8119 {Testing method for glossiness of 75 degrees mirror surface of paper and paper board}.

(9) Image Density

Printing was conducted in the same manner as in the above-mentioned ink setting property except that a process ink was used. By the use of a reflection densitometer (trade name; RD 918, manufactured by Gretag Macbeth AG.) the density of printed portion was measured.

### EXAMPLE 1

A polylactic acid film (trade name: Ecoloju SA101, manufactured by Mitsubishi Plastics Inc.) of 50 μm in thickness was coated on one surface with the coating solution having the following chemical composition-1, immersed in water for one minute, thereafter immersed in hot water at 80° C. for 10 seconds, and dried at 70° C. for one minute to form an ink receiving layer with a coat thickness of 30 μm. The evaluations in the above-mentioned items (1) through (9) were carried out. The results are given in Table 1.

Chemical Composition-1

| | |
|---|---|
| polylactic acid resin (trade name : LACEA H - 280, | 12.7 parts by mass |
| manufactured by Mitsui Chemicals Inc.) | |
| DMF | 72.0 parts by mass |
| calcium carbonate (calcium carbonate light having | 9.2 parts by mass |
| 2 μm average particle diameter, manufactured by | |
| Maruo Calcium Co., Ltd.) | |
| diatomaceous earth (trade name HIGHMICRON | |
| HE- 5 having 1.6 μm | 6.1 parts by mass |
| average particle diameter, manufactured by | |
| TAKEHARA KAGAKUKOGYO CO., ltd.) mass | |

### EXAMPLE 2

A polylactic acid film (trade name: Ecoloju SA101, manufactured by Mitsubishi Plastics Inc.) of 50 μm in thickness was coated on one side with the coating solution having the following chemical composition-2, immersed in water for one minute, thereafter immersed in hot water at 80° C. for 10 seconds, dried at 70° C. for one minute to form an ink receiving layer with coat thickness of 30 μm. The evaluations were carried out in the same manner as in Example 1. The results are given in Table 1.

Chemical Composition-2

| | |
|---|---|
| polylactic acid resin (trade name : LACEA H-280, | 12.5 parts by mass |
| manufactured by Mitsui Chemicals Inc.) | |
| DMF | 75.0 parts by mass |
| calcium carbonate (calcium carbonate light having | 11.1 parts by mass |
| 2 μm average particle diameter, manufactured by | |
| Maruo Calcium Co., Ltd.) | |
| titanium oxide (trade name: Tipaque R-820 having | 1.4 parts by mass |
| 0.3 μm average | |
| particle diameter, manufactured by Ishihara Sangyo | |
| Kaisha., Ltd.) | |

### COMPARATIVE EXAMPLE 1

In the same manner as in Example 1, an ink receiving layer was prepared except that use was made only of a polylactic acid film (trade name: Ecoloju SW501, manufactured by Mitsubishi Plastics Industries Ltd.) of 50 μm in thickness. Thus the evaluations were carried out in the same manner as in Example 1. The results are given in Table 1.

### COMPARATIVE EXAMPLE 2

In the same manner as in Example 1, an ink receiving layer was prepared except that use was made only of a polylactic acid film (trade name: Ecoloju SW501, manufactured by Mitsubishi Plastics Inc.) of 50 μm in thickness and that the ink receiving layer was roughened by means of a sandblast treatment. Thus the evaluations were carried out in the same manner as in Example 1. The results are given in Table 1.

### COMPARATIVE EXAMPLE 3

In the same manner as in Example 1, an ink receiving layer was prepared except that there was used a polylactic acid film (trade name: Ecoloju SW103, manufactured by Mitsubishi Plastics Inc.) of 50 μm in thickness and that the coating solution having the following chemical composition-3 was used. Thus the evaluations were carried out in the same manner as in Example 1. The results are given in Table 1

| | |
|---|---|
| polylactic acid resin (trade name: LACEA H-280, | 8.0 parts by mass |
| manufactured by Mitsui Chemicals Inc.) | |
| mixed solvent (toluene, ethyl acetate, methyl ethyl | 58.7 parts by mass |
| ketone = 4:3:3 | |
| solvent (propylene glycol monomethyl ether) | 28.0 parts by mass |
| calcium carbonate (calcium carbonate light having | 0.8 parts by mass |
| 2 μm average particle diameter, manufactured by | |
| Maruo Calcium Co., Ltd.) | |
| silica (trade name: Mizukasil P526, having 6.4 μm | 2.4 parts by mass |
| average particle diameter, manufactured by | |
| Mizusawa Industrial Chemicals. Ltd.) | |
| titanium oxide (trade name: Tipaque R-670 having | 1.3 parts by mass |
| 0.2 μm average | |
| particle diameter, manufactured by Ishihara Sangyo | |
| Kaisha, Ltd.) | |

### COMPARATIVE EXAMPLE 4

In the same manner as in Example 1, an ink receiving layer was prepared by using a polylactic acid film (trade name: Ecoloju SA101, manufactured by Mitsubishi Plastics Inc.) of 50 μm in thickness except that the coating solution having the chemical composition-2 was used, and that heating drying procedure was carried out at 120° C. for 5 minutes instead of at 70° C. for one minute. Thus the evaluations were carried out in the same manner as in Example 1. The results are given in Table 1.

### COMPARATIVE EXAMPLE 5

In the same manner as in Example 1, an ink receiving layer was prepared by using a polylactic acid film (trade name: Ecoloju SA101, manufactured by Mitsubishi Plastics Inc.) of 50 μm in thickness, except that the coating solution having the following chemical composition-4 was used, and that an ink receiving layer with a coat thickness of 15 μm instead of 30 μm was prepared. Thus the evaluations were carried out in the same manner as in Example 1. The results are given in Table 1

| | |
|---|---|
| polylactic acid resin (trade name: LACEA H-280, | 4.8 parts by mass |
| manufactured by Mitsui Chemicals Inc.) | |
| DMF | 70.0 parts by mass |
| calcium carbonate (calcium carbonate light having | 15.1 parts by mass |
| 2 μm average particle diameter, manufactured by | |
| Maruo Calcium Co., Ltd.) | |
| hydrous aluminum silicate | 10.1 parts by mass |
| (SPECIALKAOLINCLAY having 7.0 μm average | |
| particle diameter, manufactured by TKEHARA | |
| KAGAKU KOGYO CO., Ltd.) | |

TABLE 1

| | Example No | | Comparative Example No | | | | |
|---|---|---|---|---|---|---|---|
| | 1 | 2 | 1 | 2 | 3 | 4 | 5 |
| {Physical properties | | | | | | | |
| of recording | | | | | | | |
| surface} | | | | | | | |
| smoothness (sec) | 4500 | 8400 | 14000 | 500 | 190 | 1000 | 2000 |
| average pore | 0.4 | 1.0 | — | — | — | 11.0 | 2.0 |
| diameter (μm) | | | | | | | |
| {Composition of | | | | | | | |
| Coating solution} | | | | | | | |
| Filler / resin | 1.2 | 1.0 | — | — | 0.6 | 1.0 | 5.3 |
| (mass ratio) | | | | | | | |
| {Evaluation of | | | | | | | |
| material for | | | | | | | |
| recording thereon} | | | | | | | |
| ink setting property | | | | | | | |
| process ink | ◯ | ◯ | X | Δ | Δ | ◯ | ◯ |
| soybean oil ink | ◯ | ◯ | X | Δ | Δ | ◯ | ◯ |
| non-VOC ink | ◯ | ◯ | X | Δ | Δ | ◯ | ◯ |
| {Printing | | | | | | | |
| adaptability} | | | | | | | |
| inkjet recording | ◯ | ◯ | ◯ | ◯ | ◯ | ◯ | ◯ |
| thermal transfer | ◯ | ◯ | Δ | ◯ | ◯ | ◯ | ◯ |
| recording | | | | | | | |
| Writing properties | ◯ | ◯ | X | ◯ | ◯ | ◯ | ◯ |
| Stamping properties | ◯ | ◯ | X | ◯ | ◯ | ◯ | ◯ |
| Adhesiveness | ◯ | ◯ | — | — | ◯ | ◯ | X |
| Biodegradability | ◯ | ◯ | — | — | Δ | ◯ | ◯ |
| Glossiness (%) | | | | | | | |
| printed portion | 65 | 69 | 90 | 10 | 42 | 8 | 15 |
| non-printed portion | 54 | 27 | 87 | 6 | 15 | 7 | 10 |
| Printing density | 1.8 | 1.5 | 2.3 | 1.4 | 1.9 | 1.1 | 1.3 |

What is claimed is:

1. A material for recording thereon which comprises a biodegradable resin and at least one surface of which is a porous recording surface, wherein said porous recording surface contains (A) a biodegradable resin and (B) a natural inorganic filler and/or an organic filler in a mass ratio (B)/(A) being in the range of 0.1 to 5.0, and possesses a smoothness of at least 500 sec and besides an average pore diameter in the range of 0.01 to 10 μm.

2. The material for recording thereon as set forth in claim 1, which is of a monolayer structure containing (A) a biodegradable resin and (B) a natural inorganic filler and/or an organic filler.

3. The material for recording thereon as set forth in claim 1, which is of a multilayer structure wherein a layer having a porous recording surface containing (A) a biodegradable resin and (B) a natural inorganic filler and/or an organic filler is formed on at least one surface of a substrate composed principally of a biodegradable resin.
